(19) United States
(12) Patent Application Publication
(10) Pub. No.: US 2025/0378724 A1
(43) Pub. Date: Dec. 11, 2025

(54) SYSTEM AND METHOD FOR GENERATING AUTOMATED POST-MISSION FLIGHT LOGS USING GENERATIVE AI IN UNMANNED VEHICLE OPERATIONS

(71) Applicant: Angelo Thomas Niforatos, Fayetteville, NY (US)

(72) Inventor: Angelo Thomas Niforatos, Fayetteville, NY (US)

(21) Appl. No.: 19/180,616

(22) Filed: Apr. 16, 2025

Related U.S. Application Data
(63) Continuation-in-part of application No. 18/739,517, filed on Jun. 11, 2024.

(51) Int. Cl. G07C 5/08; G06F 11/34

(52) U.S. Cl. CPC G07C 5/0841; G06F 11/3476

(57) ABSTRACT

A system and method for automated post-mission logging of unmanned vehicle operations using generative AI. Flight telemetry, operator notes, and maintenance data are aggregated and normalized into a standardized dataset. A large language model interprets the dataset to generate user-readable debriefs, compliance records, and maintenance logs. The system ensures each post-mission report conforms to regulatory standards and automatically flags anomalies or compliance deviations. The generative AI module may be fine-tuned on domain-specific datasets to produce logs that are structurally consistent with predefined templates and compliance forms. The resulting reports can be stored, retrieved, and shared via secure cloud services, streamlining flight record-keeping and maintenance planning.

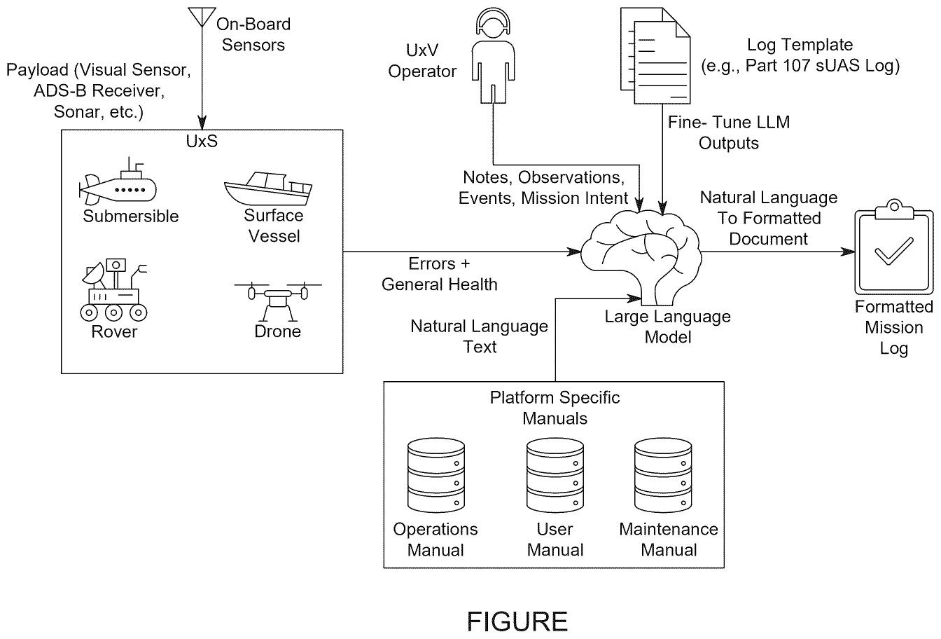

### CROSS REFERENCE TO RELATED APPLICATION

This application is a continuation-in-part of U.S. application Ser. No. 18/739,517, filed Jun. 11, 2024, which is incorporated herein by reference.

### BACKGROUND OF THE INVENTION

The present invention relates generally to systems and methods for automated generation of post-mission documentation for unmanned vehicle operations. More specifically, it relates to leveraging large language models or other generative AI techniques to transform flight, operator's notes, and maintenance data into standardized compliance logs, pilot debrief reports, and maintenance records.

Unmanned aerial systems (UAS)—including small UAS—are increasingly employed for commercial, industrial, and recreational purposes. Traditional post-mission logging often involves manual data transcription, requiring operators to summarize flight details, note any maintenance issues, and ensure compliance with regulatory requirements.

In some existing solutions, flight data is captured through onboard sensors and transferred to a cloud-based platform. However, present systems typically require significant manual input from the pilot or operator to convert raw data into a formal flight log or compliance documentation. Automating this workflow has become more critical as both regulatory bodies (e.g., the FAA) and enterprise customers demand thorough and accurate flight records.

Although some patents address automated flight log generation or real-time anomaly detection, there remains a need for a fully integrated, AI-driven system that ingests raw flight data, pilot remarks, and regulatory standards, then outputs polished, human-readable post-mission logs and maintenance records suitable for compliance and operator review. The present invention addresses this need.

### SUMMARY OF THE INVENTION

The invention provides a system and method for generating automated post-mission logs for unmanned vehicles including unmanned aerial systems (UAS), unmanned ground vehicles (UGVs), and unmanned marine vehicles using large language models (LLMs). The system collects operational data directly from the UxV (e.g., flight telemetry, maintenance statuses, reported errors) as well as operator notes during or after the mission. An AI engine processes the raw sensor data and textual inputs, identifies critical events, and cross-references federal or organizational standards to create a comprehensive, compliant post-mission log.

The method may include:
1. Data Collection from onboard sensors, ground control stations, or other telemetric sources.
2. Preprocessing and Aggregation of flight data, including geospatial details, flight duration, battery levels, anomaly flags, maintenance intervals, and operator notes.
3. Generative AI Analysis, wherein a large language model interprets the aggregated data to identify notable mission events, compliance requirements, or anomalies.
4. Automated Report Generation, producing structured flight logs, maintenance reports, and textual summaries that meet regulatory guidelines and/or client needs.
5. Post-Processing and Distribution, storing or transmitting final reports to relevant stakeholders or regulatory authorities.

Through this approach, the invention reduces human error, accelerates post-mission documentation, and delivers uniform reporting standards across varied unmanned vehicles.

These and other features, aspects and advantages of the present invention will become better understood with reference to the following drawings, description and claims.

### BRIEF DESCRIPTION OF THE DRAWINGS

The Figure depicts the overall system architecture showing data flow from various external sources that feed the output of a cohesive mission log in accordance with a preferred embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

### System Overview

The proposed system, referred to here as “TitanOps”, comprises:
Unmanned Vehicle Platform (UVP): A drone or other unmanned vehicle equipped with a flight controller, sensors (GPS, altimeter, accelerometer), and communication modules (4G/LTE, Wi-Fi, or other).
Ground Control Station (GCS): Where the operator manages operations and mission parameters; typically includes a tablet or laptop running mission software.
LLM-Based Processing Module: A cloud service or local server that uses a large language model (e.g., GPT-style transformer) to parse raw data, interpret events, and generate text-based summaries.
Compliance and Maintenance Database: A repository of known maintenance schedules, checklists, regulatory requirements (FAA, local aviation bodies), and standard formats for flight logs. Compliance rules are stored in a machine-readable format (e.g., JSON or YAML schemas) enabling the AI to programmatically detect non-compliance conditions and annotate summaries accordingly.
Report Generation and Storage: A service that constructs the final flight report and stores it securely. This module can also push the report to external parties or regulatory agencies.

### Data Collection and Aggregation

During flight, the UVP streams real-time telemetry (heading, altitude, battery status, GPS position), event logs (takeoff, landing, waypoints), and any anomalies detected (e.g., motor temperature spikes). The GCS or pilot enters notes regarding mission objectives or incidents (e.g., “turbulent weather,” “observed obstacle at waypoint 3”). These data streams are aggregated on a cloud server with timestamps and metadata, forming a complete mission dataset.

### Preprocessing and Feature Extraction

A preprocessing layer normalizes the data. For example, it:
Converts raw sensor values to standardized units.
Removes extraneous or redundant points (e.g., if the telemetry feed outputs at 200 Hz, it may be subsampled to a manageable rate).
Correlates pilot remarks with the relevant portions of flight telemetry (e.g., matching a pilot's note at 2:15 PM with the latitude/longitude at that time).

### Generative AI Analysis

Core Innovation: A large language model (LLM) is fine-tuned or prompt-engineered specifically for flight-log generation. This AI reads a structured representation of the flight data, cross-checks any anomalies against known rules (e.g., altitude limit, restricted airspace boundaries), and analyzes operator notes.

The LLM then constructs a natural language debrief in agreement with the specified mission log template highlighting: The flight purpose and objectives, as described by the operator.
Key mission events (e.g., launch, waypoint transitions, landings).
Any deviations from a planned flight operation or anomalies (e.g., strong winds, battery anomalies).
Compliance checks against local or federal regulations.
Maintenance triggers or recommended inspection items (e.g., if the flight hours exceed certain thresholds or if sensors detect mechanical stress).

The inventive step here is leveraging a natural-language-generation approach to synthesize a cohesive document rather than merely logging numeric data. The LLM's advanced contextual capabilities transform flight data into a readable and actionable summary.

In some embodiments, the large language model is fine-tuned using a curated corpus of historical flight logs, maintenance reports, and compliance templates. This fine-tuning process involves supervised learning techniques where the LLM is trained to generate outputs that align with predefined log formats, regulatory standards, and mission documentation styles. By aligning the model's output distribution with mission-specific report structures, the system ensures that each generated log adheres to syntactic and semantic expectations of regulatory bodies and enterprise customers. The LLM applies a template-guided decoding strategy to constrain output to match predefined log layouts (e.g., FAA Form 107, ASTM maintenance log schemas), enabling consistent formatting across missions.

The system may further implement a reinforcement learning or prompt calibration phase where model outputs are scored against a set of compliance checklists and formatting rules to iteratively improve the fidelity of the generated logs. This allows the AI to learn not only what to say, but how to say it—in strict accordance with standardized log schemas.

Automated Report Generation Once the LLM finishes its analysis, the system generates one or more standardized report formats:
Compliance Flight Log: A structured table or form mandated by authorities (e.g., FAA).
Maintenance Log: A summary of usage hours, flight anomalies, recommended maintenance tasks.
Pilot Debrief: A narrative-style document, summarizing the mission and highlighting key lessons or warnings.
Custom Flight Log: Depending on a customer's needs, a custom report can be generated to provide system flexibility.

The system can present these documents to the operator through a web portal, mobile app, or PDF/printed output. Optionally.

It should be understood, of course, that the foregoing relates to exemplary embodiments of the invention and that modifications may be made without departing from the spirit and scope of the invention as set forth in the following claims.

What is claimed is:

1. A system for generating automated post-mission logs for an unmanned vehicle, the system comprising:
a data collection module configured to receive flight telemetry data, operator inputs, and maintenance status information from an unmanned vehicle;
a preprocessing module configured to normalize and aggregate the received data into a standardized data set;
a generative AI module comprising a transformer-based large language model and configured to:
interpret the standardized data set, including operator inputs and flight telemetry;
identify operational events and anomalies; and
generate a textual summary of mission events and compliance information;
a report generation module configured to produce one or more post-mission logs based on the textual summary, wherein the post-mission logs conform to a regulatory compliance format,
wherein the generative AI module leverages a large language model to transform the standardized data set into a human-readable report that includes maintenance recommendations and regulatory compliance indicators,
wherein the generative AI module is further configured to reject or request clarification of ambiguous operator inputs based on confidence thresholds, and
wherein the system operates in an offline or air-gapped environment without requiring internet connectivity during report generation.

2. The system of claim 1, wherein the data collection module is further configured to receive real-time operator commentary through a voice-to-text interface, and the generative AI module integrates said commentary into the textual summary where said commentary is timestamp-aligned to the telemetry data for contextual integration.

3. The system of claim 1, wherein the report generation module automatically submits the post-mission logs to a regulatory authority via an electronic transmission interface.

4. The system of claim 1, wherein the storage module uses a blockchain-based ledger to ensure immutability and verifiability of the post-mission logs, wherein each log entry is hashed and stored on a distributed ledger with a time-based signature to ensure chain-of-custody integrity.

5. The system of claim 1, wherein the generative AI module is fine-tuned using a corpus of historical flight logs, domain-specific maintenance procedures, and regulatory compliance forms to increase contextual accuracy to enhance its accuracy.

6. The system of claim 1, wherein the generative AI module is fine-tuned using a corpus of historical flight logs and regulatory templates to produce outputs that conform to predefined report structures.

7. The system of claim 6, wherein the fine-tuning includes (i) supervised learning to align outputs with known log formats, and (ii) reinforcement learning based on compliance pass/fail criteria scored against a rule-based evaluation engine phases to align generated outputs with compliance criteria and log formatting standards.

8. A method of generating post-mission logs for unmanned vehicle operations, the method comprising:
receiving flight telemetry data, operator notes, and maintenance information related to an unmanned vehicle;
aggregating and normalizing the data to produce a standardized dataset;
applying a large language model to the standardized dataset to identify anomalies, compliance requirements, and mission events;
generating a textual debrief and structured compliance report; and
storing or transmitting the textual debrief and compliance report, thereby providing a record of unmanned vehicle operations in a standardized format.
